(19) United States
(12) Patent Application Publication
(10) Pub. No.: US 2004/0133779 A1
(43) Pub. Date: Jul. 8, 2004

(54) Interconnecting device, communication-setting program, and method thereof

(76) Inventors: Takayuki Sato, Tokyo (JP); Jun Haneda, Tokyo (JP)

Correspondence Address: EDWARDS & ANGELL, LLP, P.O. BOX 55874, BOSTON, MA, 02205, US

(21) Appl. No.: 10/661,158

(22) Filed: Sep. 11, 2003

Related U.S. Application Data
(63) Continuation of application No. PCT/JP02/07034, filed on Jul. 11, 2002.

(30) Foreign Application Priority Data
Aug. 23, 2001 (JP) JP 2001-253246

(51) Int. Cl. H04L 9/00

(52) U.S. Cl. 713/168

(57) ABSTRACT

An interconnecting device for interconnecting communication in a computer network, including: a holding unit for holding an attachable and removable nonvolatile memory; a reading unit for reading authentication information of the nonvolatile memory and settings for the computer network from the nonvolatile memory held by the holding unit; an authentication unit for authenticating whether the authentication information read by the reading unit satisfies a predetermined condition; and a transmitting unit for transmitting the settings to a communication device, which performs communication in the computer network, in order to perform communication settings of the computer network based on the settings read by the reading unit when the authentication information satisfies the predetermined condition.

This is a continuation application of PCT/JP02/07034 filed on Jul. 11, 2002, further to Japanese patent application, 2001-253246 filed on Aug. 23, 2001, the contents of which are incorporated herein by reference.

### BACKGROUND OF THE INVENTION

1. Field of the Invention

The present invention relates to an interconnecting device, a communication-setting program, and a method thereof. More particularly, the present invention relates to an interconnecting device, a communication-setting program, and a method thereof for performing communication setting of a computer network.

2. Description of the Related Art

Conventionally, a communication setting of a computer network is performed in a management server that manages a computer network in unified manner. The administrator of a computer network performs communication settings of a computer network by inputting the settings for a communication setting of a computer network in the management server.

However, recently, the function of a management server increases, and the settings for performing communication settings of the computer network in a management server also increases. Therefore, detailed communication settings for a computer network becomes difficult for the administrator.

Moreover, in each plurality of administrator and computer networks, in which communication settings are changed periodically, the administrator has to input settings in a management server whenever communication settings are changed. Thus, it takes time and effort for changing a communication setting of a computer network.

### SUMMARY OF THE INVENTION

Therefore, it is an object of the present invention to provide an interconnecting device, a communication setting program, and a method thereof, which overcomes the above issues in the related art. This object is achieved by combinations described in the independent claims. The dependent claims define further advantageous and exemplary combinations of the present invention.

According to the first aspect of the present invention, an interconnecting device for interconnecting a communication in a computer network, comprises: a holding unit for holding attachable and removable nonvolatile memory; a reading unit for reading authentication information of the nonvolatile memory and settings for the computer network from the nonvolatile memory held by the holding unit; an authentication unit for authenticating whether the authentication information read by the reading unit satisfies a predetermined condition; and a transmitting unit for transmitting the settings to a communication device, which performs communication in the computer network, in order to perform communication settings of the computer network based on the settings read by the reading unit when the authentication information satisfies the predetermined condition.

The nonvolatile memory may further have a decoder that stores encoded the settings and decodes the settings read by the reading unit. The interconnecting device may further comprise a setting unit that performs communication settings of the interconnecting device based on the settings read by the reading unit.

The transmitting unit may transmit the settings read by the reading unit to other interconnecting devices in order to perform communication settings of the other interconnecting devices. The transmitting unit may transmit the settings read by the reading unit to a management apparatus that manages the computer network in order to perform communication settings of the computer network by the management apparatus.

The interconnecting device may further comprises receiving unit for receiving a setting change request signal, which is a signal that requests change of communication settings of the interconnecting device, transmitted by the management apparatus based on the settings; and setting unit for performing communication settings of the interconnecting device based on the setting change request signal receipt by the receiving unit.

The reading unit may read VLAN configuration information of the computer network from the nonvolatile memory; and the transmitting unit may transmit the VLAN configuration information to the management apparatus in order to set VLAN configuration of the computer network by the management apparatus.

The receiving unit may receive a VLAN setting change request signal that requests change of VLAN settings of the interconnecting device, transmitted by the management apparatus based on the VLAN configuration information; and the setting unit may perform VLAN setting of the interconnecting device based on the VLAN setting change request signal received by the receiving unit.

The interconnecting device may further comprise a storage unit for storing device identification information of at least one of a communication device that is permitted to communicate with the interconnecting device; and a communication controller for restricting the communication device that is permitted to communicate with the interconnecting device based on the device identification information stored in the storage unit.

The communication controller may not restrict the communication device that is permitted to communicate with the interconnecting device when the holding unit holds the nonvolatile memory.

According to the second aspect of the present invention, a communication setting program used for an interconnecting device that performs communication settings of a computer network; comprises: a reading module for reading authentication information of attachable and removable nonvolatile memory and settings for the computer network from the nonvolatile memory; an authentication module for authenticating whether the authentication information read by the reading module satisfies a predetermined condition; and a transmitting module for transmitting the settings to a communication device, which performs communication in the computer network, in order to perform communication settings of the computer network based on the settings read by the reading module when the authentication information satisfies the predetermined condition.

The transmitting module may transmit the settings read by the reading module to other interconnecting devices in order to perform communication settings of the other interconnecting devices. The transmitting module may transmit the settings to the management apparatus in order to perform communication settings of the computer network by the management apparatus that manages the computer network.

According to the third aspect of the present invention, a method for setting communication of a computer network by an interconnecting device that interconnects communication in the computer network, comprises: holding an attachable and removable nonvolatile memory; reading authentication information of the nonvolatile memory and settings for the computer network from the held nonvolatile memory; authenticating whether the read authentication information satisfies a predetermined condition; and transmitting the settings to a communication device, which performs communications in the computer network, in order to perform communication settings of the computer network based on the read settings when the authentication information satisfies the predetermined condition.

This summary of the invention does not necessarily describe all necessary features of the present invention. The present invention may also be a sub-combination of the above-described features. The above and other features and advantages of the present invention will become more apparent from the following description of embodiments taken in conjunction with the accompanying drawings.

### BRIEF DESCRIPTION OF THE DRAWINGS

FIG. 1 shows a configuration of a computer network 100 according to the present embodiment.

FIG. 2 shows a configuration of the interconnecting device 10a according to the present embodiment.

FIG. 3 shows an example of the data format of a VLAN configuration information file.

FIG. 4 shows an example of the VLAN configuration of a computer network 100.

FIG. 5 shows hardware components in the management apparatus 20.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

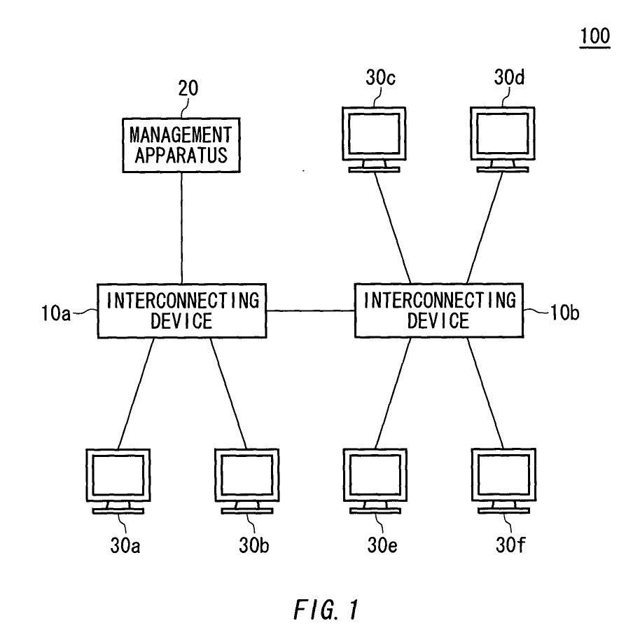

FIG. 1 shows a configuration of a computer network 100 according to the present embodiment. The computer network 100 of the present embodiment has interconnecting devices 10a and 10b, the management apparatus 20, and the communication devices 30a, 30b, 30c, 30d, 30e, and 30f.

The interconnecting devices 10a and 10b, such as the switching hub, relay the communication in a computer network 100. The management apparatus 20 manages the communication in a computer network 100. The communication devices 30a, 30b, 30c, 30d, 30e, and 30f perform communications in a computer network 100.

Interconnecting devices 10a and 10b read the settings of a computer network 100 from a nonvolatile memory, such as an integrated circuit card, a Miniature Card, and a floppy disk, and transmit the settings to the management apparatus 20. Then, the management apparatus 20 transmits the setting change request signal, which requests to change each communication setting of the interconnecting devices 10a and 10b, to each of the interconnecting devices 10a and 10b based on the settings received from the interconnecting devices 10a or 10b. Each interconnecting device 10a and 10b performs each communication settings of the interconnecting devices 10a and 10b based on the setting change request signal received from the management apparatus 20.

For example, the interconnecting devices 10a and 10b read the VLAN configuration information of a computer network 100 from a nonvolatile memory and transmit the VLAN configuration information to the management apparatus 20. The management apparatus 20 transmits the VLAN setting change request signal that requests to change each VLAN setting of the interconnecting devices 10a and 10b based on the VLAN configuration information received from the interconnecting devices 10a or 10b. Furthermore, each interconnecting device 10a and 10b performs each communication setting of the interconnecting device 10a and 10b based on the VLAN setting change request signal received from the management apparatus 20.

Moreover, in other examples, each of interconnecting devices 10a and 10b may read the settings of a computer network 100 from a nonvolatile memory and may perform each communication settings of the interconnecting device 10a and 10b based on the read settings, respectively. Furthermore, the interconnecting device 10a may transmit the settings read from a nonvolatile memory to the interconnecting device 10b in order to make the interconnecting device 10b to perform the communication settings of the interconnecting device 10b. The interconnecting device 10b may perform a communication setting of the interconnecting device 10b based on the settings received from the interconnecting device 10a.

Moreover, the interconnecting device 10b may transmit the settings read from nonvolatile memory to the interconnecting device 10a so as to make the interconnecting device 10a to perform communication settings of the interconnecting device 10a. The interconnecting device 10a may also perform communication settings of the interconnecting device 10a based on the settings received from the interconnecting device 10b.

The administrator of a computer network 100 stores beforehand the settings, for making communication settings of a computer network 100 the communication settings necessary for the administrator. The administrator performs communication settings of a computer network 100 by inserting the nonvolatile memory, which stores settings, into the interconnecting device 10a or 10b when making communication settings of a computer network 100 necessary for the administrator.

According to the computer network 100 of the present embodiment, the administrator of a computer network 100 can easily perform communication settings, such as changing the VLAN configuration of a computer network 100, only by inserting the nonvolatile memory into the interconnecting device 10a or 10b.

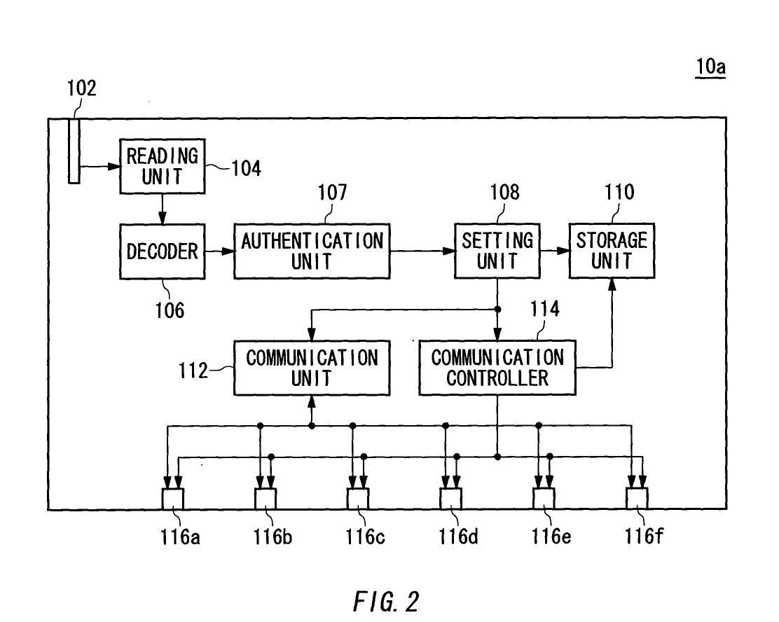

FIG. 2 shows a configuration of the interconnecting device 10a according to the present embodiment. The interconnecting device 10a and the interconnecting device 10b have the same configuration. Thus, the configuration and operation of the interconnecting device 10a is explained below as a representation of the interconnecting device.

The interconnecting device 10a has a holding unit 102, a reading unit 104, a decoder 106, an authentication unit 107, a setting unit 108, a storage unit 110, a communication unit 112, a communication controller 114, and connection ports 116a, 116b, 116c, 116d, 116e, and 116f.

The holding unit 102 holds the attachable and removable nonvolatile memory. The reading unit 104 reads the authentication information of the nonvolatile memory and the settings for the computer network 100 from the nonvolatile memory. The decoder 106 decodes encoded apparatus identification information. The authentication unit 107 authenticates the authentication information read by the reading unit 104. The setting unit 108 performs communication settings of the interconnecting device 10a based on the settings read by the reading unit 104.

The storage unit 110 stores the apparatus identification information of at least one of the communication devices, which is permitted to communicate with the interconnecting device 10a. The communication unit 112 transmits and receives data to and from the management apparatus 20. The communication controller 114 controls the communication with the interconnecting device 10a. The connection ports 116a, 116b, 116c, 116d, 116e, and 116f, to which the communication device is connected.

The holding unit 102 holds the nonvolatile memory in which the settings for the computer network 100 is stored. Moreover, the nonvolatile memory stores the authentication information for authenticating the nonvolatile memory. The reading unit 104 reads the authentication information of the nonvolatile memory and the settings for the computer network 100 from the nonvolatile memory held by the holding unit 102. The decoder 106 decodes the encoded authentication information and the encoded settings when the authentication information and the settings read from the nonvolatile memory is encoded.

Next, the authentication unit 107 authenticates whether the authentication information read from the nonvolatile memory satisfies the predetermined condition. For example, the nonvolatile memory stores the administrator identification information, by which the administrator of the computer network 100 is identified, as an example of the authentication information. Moreover, the authentication unit 107 stores beforehand the administrator identification information of the administrator, who is permitted to change the communication settings of the computer network 100. The authentication unit 107 authenticates the administrator identification information read from the nonvolatile memory based on the stored administrator identification information, and judges whether or not to permit communication settings to the computer network 100.

When the authentication information read from the nonvolatile memory satisfies the predetermined condition, the setting unit 108 performs communication settings to the interconnecting device 10a based on the settings read from the nonvolatile memory. Moreover, when the authentication information read from nonvolatile memory satisfies the predetermined condition, the communication unit 112 transmits the settings read from the nonvolatile memory to the management apparatus 20 based on the settings read from the nonvolatile memory in order to perform communication settings to the computer network 100. Moreover, the communication unit 112 may transmit the settings read from the nonvolatile memory to the interconnecting device 10b in order to make the interconnecting device 10b to perform a communication setting to the interconnecting device 10b.

Moreover, the communication unit 112 receives the setting change request signal that requests the change of communication settings to the interconnecting device 10a transmitted based on the settings received from the interconnecting device 10a by the management apparatus 20. The setting unit 108 performs communication settings of the interconnecting device 10a based on the setting change request signal received by the communication unit 112.

For example, the reading unit 104 reads the VLAN configuration information of a computer network 100 from the nonvolatile memory. The communication unit 112 transmits the VLAN configuration information read from nonvolatile memory to the management apparatus 20 in order to make the management apparatus 20 set the VLAN configuration of a computer network 100. The communication unit 112 receives the VLAN setting change request signal, which requests the change of a VLAN setting of the interconnecting device 10a transmitted by the management apparatus 20 based on the VLAN configuration information received from the interconnecting device 10a.

Next, the setting unit 108 performs a VLAN setting of the interconnecting device 10a based on the VLAN setting change request signal received by the communication unit 112. Then, the storage unit 110 stores the VLAN configuration information of the interconnecting device 10a using the setting of the setting unit 108. Then, the communication controller 114 controls the communication in the connection ports 116a, 116b, 116c, 116d, 116e, and 116f based on the VLAN configuration information stored in the storage unit 110.

Moreover, the storage unit 110 stores the apparatus identification information of the communication device, which is permitted to communicate with the interconnecting device 10a. The communication controller 114 restricts the communication device, which is permitted to communicate with the interconnecting device 10a based on the apparatus identification information stored in the storage unit 110. Moreover, when the holding unit 102 holds the nonvolatile memory, the communication controller 114 may not need to restrict the communication device that permits the communication in the interconnecting device 10a. Moreover, the communication controller 114 may restrict the communication device that permits the communication in the interconnecting device 10a based on the apparatus identification information stored in the storage unit 110 when the nonvolatile memory is removed from the holding unit 102.

Moreover, when the nonvolatile memory is removed from the holding unit 102, the communication controller 114 may not need to restrict the communication device that permits the communication in the interconnecting device 10a for a predetermined time from the time of removal of the nonvolatile memory.

According to the interconnecting device 10a of the present embodiment, since the encoded authentication information and the encoded settings are read from the nonvolatile memory and decoded, the present embodiment can prevent the leaking of the authentication information and settings stored in the nonvolatile memory. Moreover, according to the interconnecting device 10a of the present embodiment, it is also possible to permit only to the administrator who possesses the predetermined nonvolatile memory, which stores the authentication information that satisfies the predetermined condition, to newly connect the communication device which can communicate in a computer network 100. Therefore, the present embodiment can prevent the user, who does not posses the predetermined nonvolatile memory, to intrude into the computer network 100 using an arbitrary communication device.

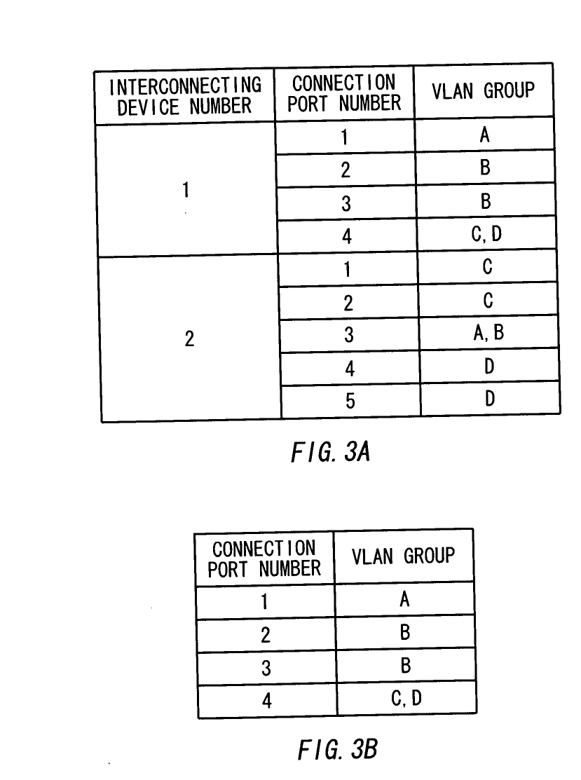

FIG. 3 shows an example of the data format of a VLAN configuration information file. FIG. 3A shows the data format of the VLAN configuration information file stored in the nonvolatile memory. FIG. 3B shows the data format of the VLAN configuration information file stored in the storage unit 110.

As shown in FIG. 3A, the VLAN configuration information file stored in the nonvolatile memory has an interconnecting device number field, a connection port number field, and a VLAN group field. The interconnecting device number field stores the interconnecting device number assigned for identifying a plurality of interconnecting devices. The connection port number field stores the connection port number assigned for identifying a plurality of connection ports. The VLAN group field stores the VLAN group, in which each connection port can communicate. In the present embodiment, the interconnecting device number of the interconnecting device 10a is set to 1, and the interconnecting device number of the interconnecting device 10b is set to 2.

Moreover, as shown in FIG. 3B, the VLAN configuration information file stored in the storage unit 110 has the connection port number field and the VLAN group field. The connection port number field stores the connection port number assigned for identifying a plurality of connection ports. The VLAN group field stores the VLAN group, in which each connection port can communicate.

The reading unit 104 reads the VLAN configuration information shown in FIG. 3A from the nonvolatile memory. The communication unit 112 transmits the VLAN configuration information read from the nonvolatile memory to the management apparatus 20. The management apparatus 20 transmits the VLAN configuration information, which corresponds to the interconnecting device number that identifies a plurality of the interconnecting devices, to each plurality of the interconnecting devices as a VLAN setting change request signal. Specifically, the management apparatus 20 transmits the VLAN configuration information corresponding to the interconnecting device number 1 to the interconnecting device 10a. Also, the management apparatus 20 transmits the VLAN configuration information corresponding to the interconnecting device number 2 to the interconnecting device 10b.

The communication unit 112 receives the VLAN configuration information from the management apparatus 20 as a VLAN setting change request signal, which changes a VLAN setting of the interconnecting device 10a. The setting unit 108 performs a VLAN setting of the interconnecting device 10a by storing the VLAN configuration information shown in FIG. 3B in the storage unit 110.

Moreover, in other examples, the setting unit 108 may store the VLAN configuration information, which corresponds to the interconnecting device number 1 among the VLAN configuration information read from the nonvolatile memory, in the storage unit 110. Moreover, the communication unit 112 may transmit the VLAN configuration information, which corresponds to each plurality of interconnecting device numbers, to each interconnecting device identified by the interconnecting device number. Specifically, the communication unit 112 may transmit the VLAN configuration information, which corresponds to the interconnecting device number 2, to the interconnecting device 10b.

Furthermore, in the computer network 100 of the present embodiment, a port based VLAN is built on the computer network 100 by inserting the nonvolatile memory, which stores the VLAN configuration information of the port based VLAN. However, a MAC Address based VLAN may be built on the computer network 100 by inserting the nonvolatile memory, which stores the VLAN configuration information of the MAC Address based VLAN, into the interconnecting device 10a.

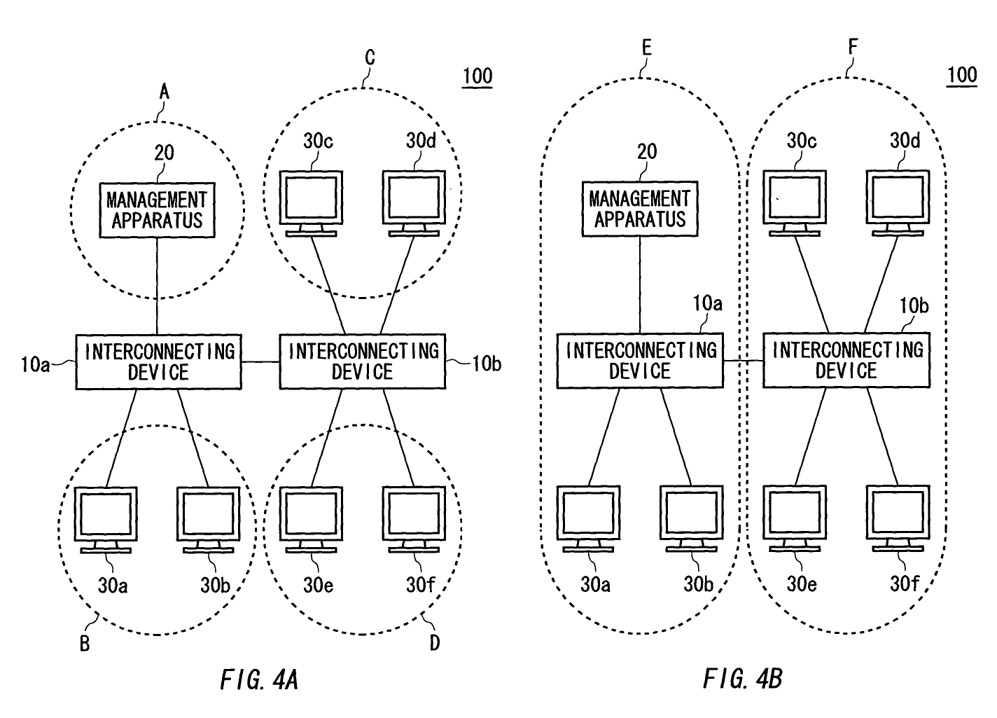

FIG. 4 shows an example of the VLAN configuration of the computer network 100. FIG. 4A shows the computer network 100, in which the VLAN configuration is built based on the VLAN configuration information shown in FIG. 3A. Furthermore, FIG. 4B shows the computer network 100, in which the VLAN configuration is built based on other VLAN configuration information.

FIG. 4A shows the computer network 100, which has the VLAN group A including the management apparatus 20, the VLAN group B including the communication devices 30a and 30b, and the VLAN group C including the communication device 30c and 30d, and the VLAN group D including the communication device 30e and 30f. FIG. 4B shows the computer network 100, which has the VLAN group E including the management apparatus 20 and the communication devices 30a and 30b and the VLAN group F including the communication devices 30c, 30d, 30e, and 30f.

The VLAN configuration as shown in FIG. 4A or 4B is built in the computer network 100 by inserting the nonvolatile memory, in which the VLAN configuration information as an example of the settings was stored, into the interconnecting device 10a or 10b by the administrator of the computer network 100.

The predetermined administrator possesses the nonvolatile memory, in which the VLAN configuration information for building the VLAN configuration shown in FIG. 4A is stored, and other administrators posses a plurality of nonvolatile memory including the nonvolatile memory, in which the VLAN configuration information for building the VLAN configuration shown in FIG. 4B is stored. The administrator builds the VLAN configuration on the computer network 100 by inserting the nonvolatile memory possessed into the interconnecting device 10a or 10b.

Moreover, the administrator may posses a plurality of nonvolatile memory including the nonvolatile memory, in which the VLAN configuration information for building the VLAN configuration shown in FIG. 4A is stored, and the nonvolatile memory, in which the VLAN configuration information for building the VLAN configuration shown in FIG. 4B was stored. Moreover, the administrator may insert the nonvolatile memory, in which the VLAN configuration information for building desired VLAN configuration is stored, into the interconnecting device 10a or 10b in order to build the desired VLAN configuration in the computer network 100.

Moreover, the administrator may change the VLAN configuration of a computer network according to the day of the week or time. For example, in the computer network built in a company, the administrator may change the VLAN configuration of a computer network between the weekday, when usual business is performed, and Saturday and Sunday, when it is a holiday. Moreover, the administrator may change the VLAN configuration of a computer network according to the difference in the usage of computer networks, such as monitoring the operation condition of a computer network, and addition of new communication devices to a computer network.

According to the computer network 100 in the present embodiment, the administrator of a computer network 100 can easily perform a communication setting, such as the change of the VLAN configuration of a computer network 100, only by inserting the nonvolatile memory into the interconnecting device 10a or 10b.

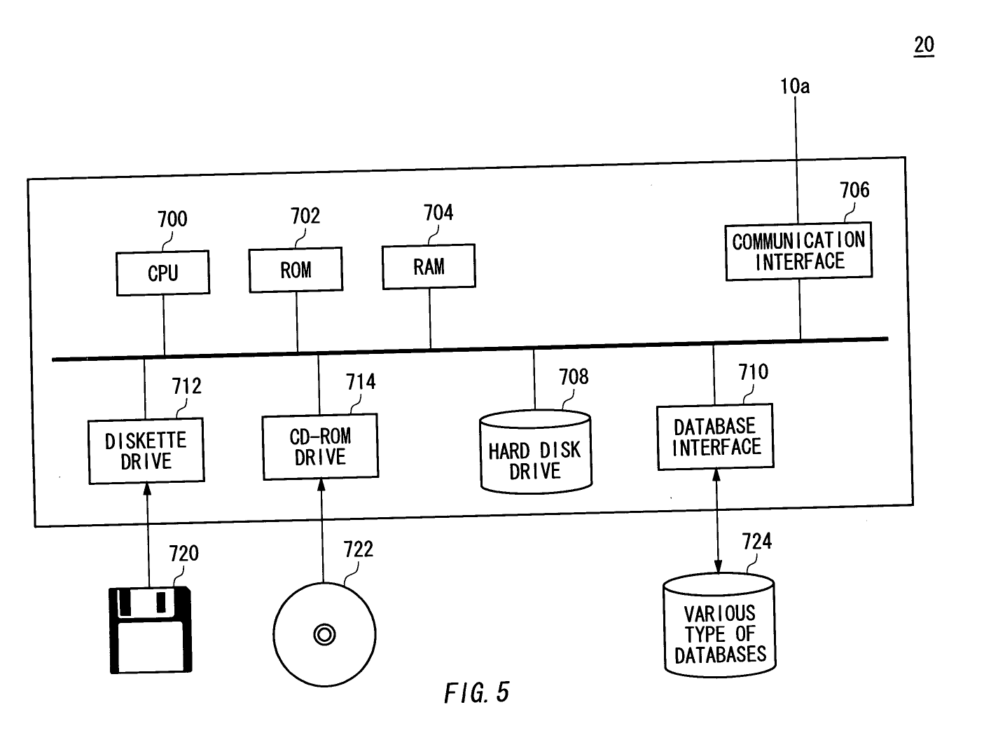

FIG. 5 shows hardware components in the management apparatus 20. The management apparatus 20 includes a CPU 700, a ROM 702, a RAM 704, a communication interface 706, a hard disk drive 708, a database interface 710, a diskette drive 712 and a CD-ROM drive 714. The CPU 700 controls each section based on the program stored in the ROM 702 and RAM 704. The communication interface 706 communicates with the interconnecting device 10a via a computer network. The database interface 710 writes data to a database and updates the contents of the database.

The diskette drive 712 reads data or program from a diskette 720 and transmits the data or the program to the communication interface 706. The CD-ROM drive 714 reads data or program from a CD-ROM 722 and transmits the data or the program to the communication interface 706. The communication interface 706 transmits the data or the program provided from the diskette drive 712 or the CD-ROM drive 714 to the interconnecting device 10a. The database interface 710 connects to various types of databases 724 and transmits and receives data to/from the various types of databases 724.

The program provided to the interconnecting device 10a is stored in a recording medium, such as the diskette 720 or the CD-ROM 722 to be provided by a user. The program stored in the recording medium may be either compressed or decompressed. The program is read from the recording medium, installed on the interconnecting device 10a via the communication interface 706, and executed on the interconnecting device 10a.

The program stored in the recording medium, that is, the program to be installed in the interconnecting device 10a includes a reading module, a setting module, a decoding module, an authentication module, a transmitting module, a storing module and a communication control module as a functional configuration. Explanation of the modules shall be omitted since each operation, which is performed by the instruction from each of the modules, is identical with that of the corresponding device in the interconnecting device 10a, which has been explained in connection with FIGS. 1 to 4.

The functions of part or all of operations of the interconnecting device 10a in all embodiments explained in the present application can be stored in the diskette 720 or the CD-ROM 722, which is examples of recording media, shown in FIG. 5.

These programs may be read directly from the recording medium and be executed by the interconnecting device 10a, or may be executed by the interconnecting device 10a after the programs are installed in the interconnecting device 10a. The programs may be stored either on a single recording medium or a plurality of recording media. The program may be stored in encoded form.

It is possible to use an optical recording medium such as DVD or PD, a magneto-optical recording medium such as a Minidisk, a tape medium, and a magnetic recording medium or a semiconductor memory such as an IC card or a Miniature Card as a recording medium instead of a diskette or a CD-ROM. A storage device, such as a hard disk or a RAM provided in a server system connected to a private communication network or the Internet, may be used as a recording medium, and the program may be provided to the interconnecting device 10a via the communication network. Such recording media shall be used only for manufacturing the interconnecting device 10a, and it is obvious that manufacturing or selling of such recording media, in the course of trade, shall be deemed to be an infringement of the patent right based on this application.

Although the present invention has been described by way of exemplary embodiments, it should be understood that many changes and substitutions may be made by those skilled in the art without departing from the spirit and the scope of the present invention which is defined only by the appended claims.

What is claimed is:

1. An interconnecting device for interconnecting communication in a computer network, comprising:
a holding unit for holding an attachable and removable nonvolatile memory;
a reading unit for reading authentication information of said nonvolatile memory and settings for said computer network from said nonvolatile memory held by said holding unit;
an authentication unit for authenticating whether said authentication information read by said reading unit satisfies a predetermined condition; and
a transmitting unit for transmitting said settings to a communication device, which performs communication in said computer network, in order to perform communication settings of said computer network based on said settings read by said reading unit when said authentication information satisfies said predetermined condition.

2. An interconnecting device as claimed in claim 1, wherein said nonvolatile memory further has a decoder that stores encoded said settings and decodes said settings read by said reading unit.

3. An interconnecting device as claimed in claim 1, further comprising a setting unit that performs communication settings of the interconnecting device based on said settings read by said reading unit.

4. An interconnecting device as claimed in claim 1, wherein said transmitting unit transmits said settings read by said reading unit to other interconnecting devices in order to perform communication settings of said other interconnecting device.

5. An interconnecting device as claimed in claim 1, wherein said transmitting unit transmits said settings read by said reading unit to a management apparatus that manages said computer network in order to perform communication settings of said computer network by said management apparatus.

6. An interconnecting device as claimed in claim 5, further comprising:
a receiving unit for receiving a setting change request signal that requests change of communication settings of the interconnecting device, transmitted by said management apparatus based on said settings; and
a setting unit for performing communication settings of the interconnecting device based on said setting change request signal receipt by said receiving unit.

7. An interconnecting device as claimed in claim 5, wherein:
said reading unit read VLAN configuration information of said computer network from said nonvolatile memory; and
said transmitting unit transmits said VLAN configuration information to said management apparatus in order to set VLAN configuration of said computer network by said management apparatus.

8. An interconnecting device as claimed in claim 7, wherein:
said receiving unit receives a VLAN setting change request signal that requests change of VLAN setting of the interconnecting device, transmitted by said management apparatus based on said VLAN configuration information; and
said setting unit performs VLAN setting of the interconnecting device based on said VLAN setting change request signal received by said receiving unit.

9. An interconnecting device as claimed in claim 1, further comprising:
a storage unit for storing device-identification-information of at least one communication device that is permitted to communicate with the interconnecting device; and
a communication controller for restricting said communication device that is permitted to communicate with the interconnecting device based on said device-identification-information stored in said storage unit.

10. An interconnecting device as claimed in claim 9, wherein said communication controller does not restrict said communication device that is permitted to communicate with the interconnecting device when said holding unit holds said nonvolatile memory.

11. A communication setting program used for an interconnecting device that performs communication settings of a computer network; comprising:
a reading module for reading authentication information of an attachable and removable nonvolatile memory and settings for said computer network from said nonvolatile memory;
an authentication module for authenticating whether said authentication information read by said reading module satisfies a predetermined condition; and
a transmitting module for transmitting said settings to a communication device, which performs communication in said computer network, in order to perform communication settings of said computer network based on said settings read by said reading module when said authentication information satisfies said predetermined condition.

12. A communication setting program as claimed in claim 11, wherein said transmitting module transmits said settings read by said reading module to other interconnecting devices in order to perform communication settings of said other interconnecting devices.

13. A communication setting program as claimed in claim 12, wherein said transmitting module transmits said settings to said management apparatus in order to perform communication settings of said computer network by said management apparatus that manages said computer network.

14. A method for setting the communication of a computer network by an interconnecting device that interconnects communication in said computer network, comprising:
holding an attachable and removable nonvolatile memory;
reading authentication information of said nonvolatile memory and settings for said computer network from said held nonvolatile memory;
authenticating whether said read authentication information satisfies a predetermined condition; and
transmitting said settings to a communication device, which performs communication in said computer network, in order to perform communication setting of said computer network based on said read settings when said authentication information satisfies said predetermined condition.
